(19) United States
(12) Patent Application Publication
(10) Pub. No.: US 2026/0084790 A1
(43) Pub. Date: Mar. 26, 2026

(54) MARINE AUDIO SYSTEM WITH SELECTABLE ATTENUATION

(71) Applicant: ASA Electronics, LLC, Elkhart, IN (US)

(72) Inventors: Gerald J. Maffetone, Edwardsburg, MI (US); Scott McMurray, Troy, MO (US); Andrew Pawling, Granger, IN (US); Don Nesbit, Knoxville, TN (US)

(73) Assignee: ASA Electronics, LLC, Elkhart, IN (US)

(21) Appl. No.: 19/340,025

(22) Filed: Sep. 25, 2025

Related U.S. Application Data
(60) Provisional application No. 63/698,791, filed on Sep. 25, 2024.

(51) Int. Cl. B63B 45/08; B63B 79/10; B63B 79/40; G06F 3/16

(52) U.S. Cl. CPC B63B 45/08; B63B 79/10; B63B 79/40; G06F 3/165; B63B 2213/02

(57) ABSTRACT

A marine audio attenuation method for use with an audio system installed on a watercraft, the method including the steps of acquiring, determining and reducing. The acquiring step acquires location information of the watercraft. The determining step determines if the watercraft is in a selected location. The reducing step reduces an audio level delivered to speakers attached to the watercraft if the watercraft is in the selected location.

### CROSS REFERENCE TO RELATED APPLICATIONS

This is a nonprovisional application of provisional application no. 63/698,791, entitled “MARINE AUDIO SYSTEM WITH SELECTABLE ATTENUATION”, filed Sep. 25, 2024, which is incorporated herein by reference.

### BACKGROUND OF THE INVENTION

### 1. Field of the Invention

The present invention relates to an audio attenuation system for use on a watercraft vehicle.

### 2. Description of the Related Art

Audio attenuation and muting are key concepts in sound engineering, electronics, and software development, especially in contexts like audio processing, telecommunications, and multimedia applications.

Audio attenuation refers to the reduction in the strength (amplitude) of an audio signal. It's a controlled decrease in volume, and not a complete silencing. A pertinent use of audio attenuation in a marine setting includes reducing the volume of audio signals when throttling down a boat, or when approaching a fishing area. This is sometimes accomplished by scaling down the amplitude of the waveform in software, as a form of digital attenuation. If an analog attenuation method is used then the adjusting of a potentiometer to reduce signal strength in hardware is undertaken. If DSP (Digital Signal Processing) is used then the system applys filters or gain reduction algorithms to accomplish the audio attenuation.

Muting is the complete suppression of an audio signal—essentially setting its amplitude to zero and can be accomplished using the above discussed ways of attenuating the audio level to zero.

In the marine environment there are often reasons to attenuate or mute the audio levels, such as noise ordinances, courtesy to others, or a change in ambient sound. It is troublesome to have to adjust the sound levels based on the environment and location of the boat.

What is needed in the art is a system that can adjust audio levels dependent on criteria that can be detected by sensor systems.

### SUMMARY OF THE INVENTION

The invention relates to the attenuation/muting of audio signal power to speakers in a changing marine environment.

The present invention in one embodiment provides a marine audio attenuation method for use with an audio system installed on a watercraft, the method including the steps of acquiring, determining and reducing. The acquiring step acquires location information of the watercraft. The determining step determines if the watercraft is in a selected location. The reducing step reduces an audio level delivered to speakers attached to the watercraft if the watercraft is in the selected location.

The present invention in the form of another embodiment provides a watercraft having a mobile floating structure with an audio system connected to the structure. The audio system having a marine audio attenuation system. The watercraft has a position locating system configured to acquire location information of the watercraft. The marine audio attenuation system is configured to carry out the steps of determining if the watercraft is in a selected location; and reducing an audio level delivered to speakers attached to the watercraft if the watercraft is in the selected location.

Advantageously the marine audio attenuation system adjusts the audio level for uses with water skiing where high audio levels projected toward the skiers is controlled based on the location of the boat towing the skier.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawing, wherein:

FIG. 1 is a top view of a watercraft having an audio system under the control of an embodiment of an attenuation system of the present invention;

FIG. 2 is a side view of the watercraft of FIG. 1 illustrating the direction of an audio projection from speakers mounted to a tower;

FIG. 3 is an illustrative functional block diagram showing elements of the audio attenuation system in use in FIGS. 1 and 2;

FIG. 4 is a flowchart illustrating an algorithm used by the audio attenuation system of FIGS. 1-3;

FIG. 5 illustrates another embodiment of the audio attenuation system of the present invention used with the watercraft of FIGS. 1 and 2;

FIG. 6 illustrates yet another embodiment of the audio attenuation system of the present invention used with the watercraft of FIGS. 1 and 2;

FIG. 7 illustrates still yet another embodiment of the audio attenuation system of the present invention used with the watercraft of FIGS. 1 and 2;

FIG. 8 illustrates a further embodiment of the audio attenuation system of the present invention used with the watercraft of FIGS. 1 and 2;

FIG. 9 illustrates a further embodiment of the audio attenuation system of the present invention used with the watercraft of FIGS. 1 and 2;

FIG. 10 illustrates a further embodiment of the audio attenuation system of the present invention used with the watercraft of FIGS. 1 and 2; and

FIG. 11 illustrates a further embodiment of the audio attenuation system of the present invention used with the watercraft of FIGS. 1 and 2.

Corresponding reference characters indicate corresponding parts throughout the several views. The exemplification set out herein illustrates at least one embodiment of the invention, and such exemplification is not to be construed as limiting the scope of the invention in any manner.

### DETAILED DESCRIPTION OF THE INVENTION

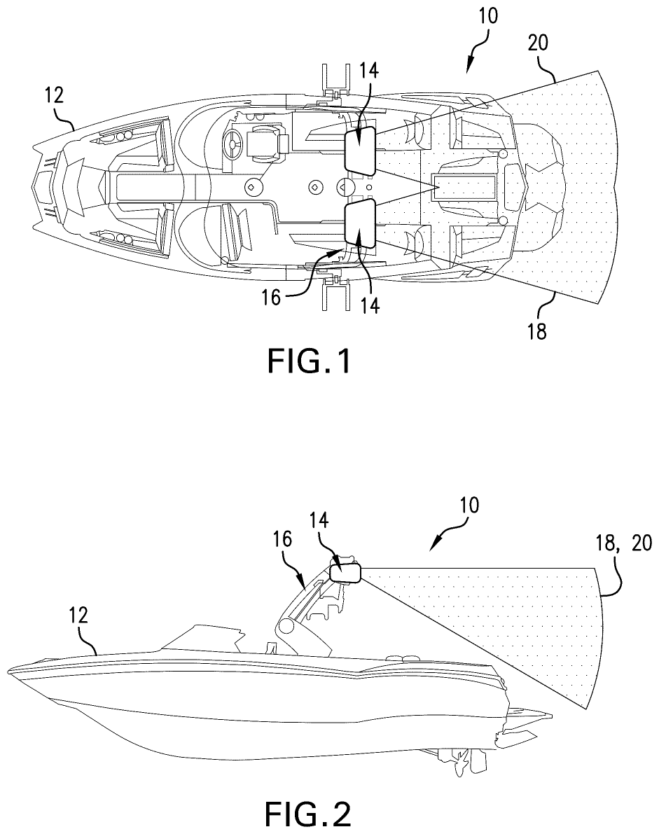

Referring now to the drawings, and more particularly to FIGS. 1 and 2, there is shown an audio attenuation system 10 installed on a watercraft 12, illustrated as a boat 12 having a mobile floating structure or hull as depicted in FIGS. 1 and 2. Audio attenuation system 10 is in control of the intensity of the audio output of tower speakers 14 that are coupled to tower 16. The main emitted audio power from speakers 14 is illustrated as audio projections 18 and 20. Audio projections 18 and 20 can be stereophonic or monophonic, and in this example would be directed toward skiers being towed by boat 12. Audio projections 18 and 20, while being depicted as being directed toward an area aft of boat 12, can in a similar manner be directed in any direction including the interior of boat 12.

Audio attenuation system 10 either completely mutes the audio emanating from speakers 14 or selectively reduces the audio power emanating from speakers 14. It is anticipated that other speakers will be present on boat 12, and these other speakers may be selectively coupled to audio attenuation system 10, or they may operate apart from audio attenuation system 10. It is further contemplated that audio attenuation system 10 may function to alter the audio output of the other speakers and speakers 14 differently as determined by an algorithm being executed by audio attenuation system 10.

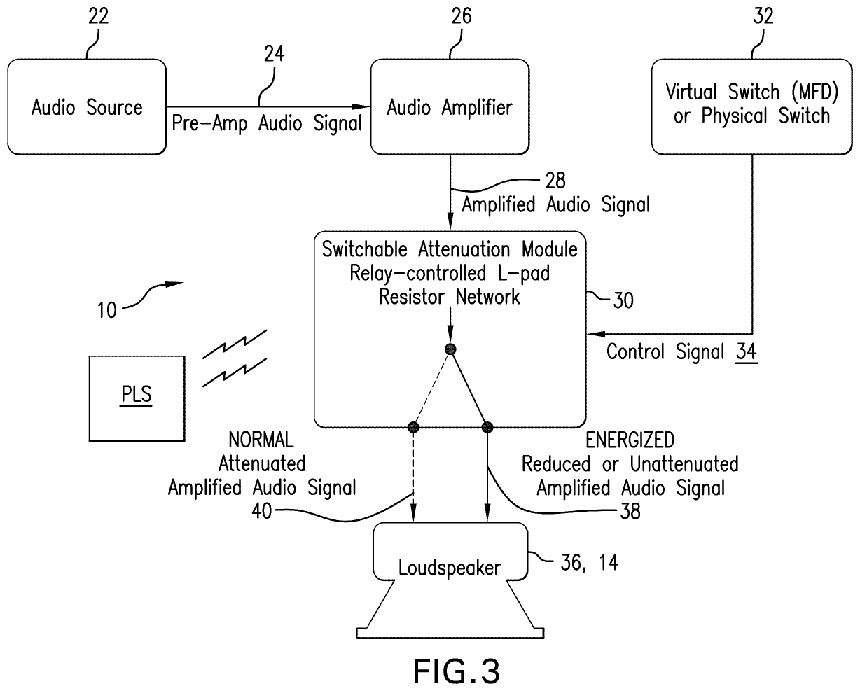

Now, additionally referring to FIG. 3 there is shown a schematical representation of an embodiment of the present invention in the form of audio attenuation system 10. The elements include audio source 22, audio amplifier 26, switchable attenuation module 30, switch 32 and speakers 36. Speakers 36 can represent the other speakers discussed above and/or speakers 14. Audio source 22 can be any source that is receiving audio information, such as a radio, or any of the myriad of sound sources containing stored audio information. Audio amplifier 26 is, as the title indicates an amplifier of audio signals, such as audio signal 24. Audio amplifier 26 supplies an amplified audio signal 28 to switchable attenuation module 30.

In one embodiment of the present invention, for a fishing boat 12, which has no tower, the audio attenuation system 10 uses selective attenuation that is focused on attenuating or muting speakers that are located in or near the hull of boat 12 and only allowing the speakers to emit audio, at a lower or minimal volume that are located away from the hull. This embodiment is characterized by a naming of it as a Reel Quiet embodiment.

Switch 32 can be a physical switch 32 or a virtual switch 32, or a relay 32. Further switch 32 may allow for a variable control of attenuation system 10. Control signal 34 may be a binary signal in that it either signals module 30 to engage an attenuation feature or disengage the attenuation feature of module 30. Or, control signal 34 may signal module 30 to perform a modified attenuation of signal 28.

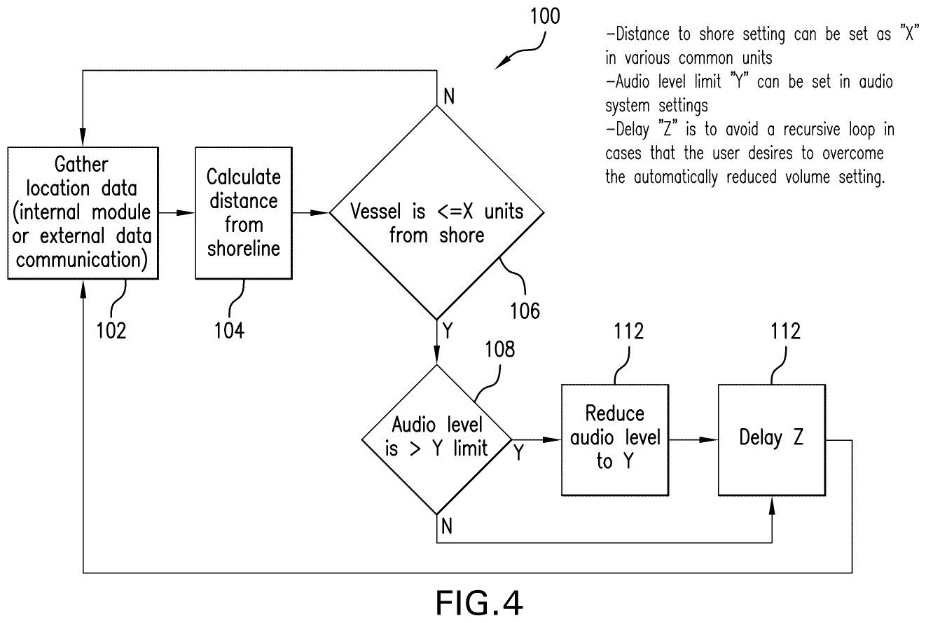

Switchable attenuation module 30 is arranged to provide an unattenuated audio signal 38 from audio amplifier 26 to speaker 36, or an attenuated audio signal 40 to speaker 36, under the control of switch 32 and/or an algorithm described in method 100, illustrated in FIG. 4.

Method 100 includes a determining location step 102, a calculating step 104, a decision step 106, another decision step 108, an adjusting audio step 110 and a delaying step 112. At step 102 method 100 determines the location of boat 12, that information is used in step 104 to determine the distance between boat 12 and a shoreline. At step 106, if boat 12 is less than distance X from shore then method 100 proceeds to step 108, otherwise method 100 proceeds to step 102. The decision at step 108 is to determine if the audio level output of speakers 14 (or all speakers on boat 12) is above a predetermined level Y, if so, then method 100 proceeds to step 110, otherwise method 100 proceeds to step 112. At step 110, the audio level of all or selected sets of speakers, is reduced to level Y. At step 112 system 10 is delayed for a time Z, then method 100 proceeds back to step 102, which serves to reduce the switching of audio levels rapidly back and forth if watercraft 12 is operating along the edge of the selected location. While this illustration uses the distance from shore as a triggering event, other triggering events are also contemplated and are discussed herein. Step 110, can be, as illustrated in at least some of the figures, a selective change in the audio level of all frequency ranges of the audio or a specific frequency range of the audio output. It is also a part of this invention to alter the audio levels to a higher level when the triggering criteria is removed or selectively disabled. The present invention is advantageously also used to emphasize and de-emphasize the high frequency drivers within the tower. This provides a method to boost the high frequency drivers to a level that is significantly louder than the other drivers. This feature is useful when you want extra volume to clearly project the tower sound to a further distance (such as when you are Skiing or Wakeboarding 80 ft behind the boat). However, this same boosted level would be very unpleasant when you are surfing only 10 ft behind the boat.

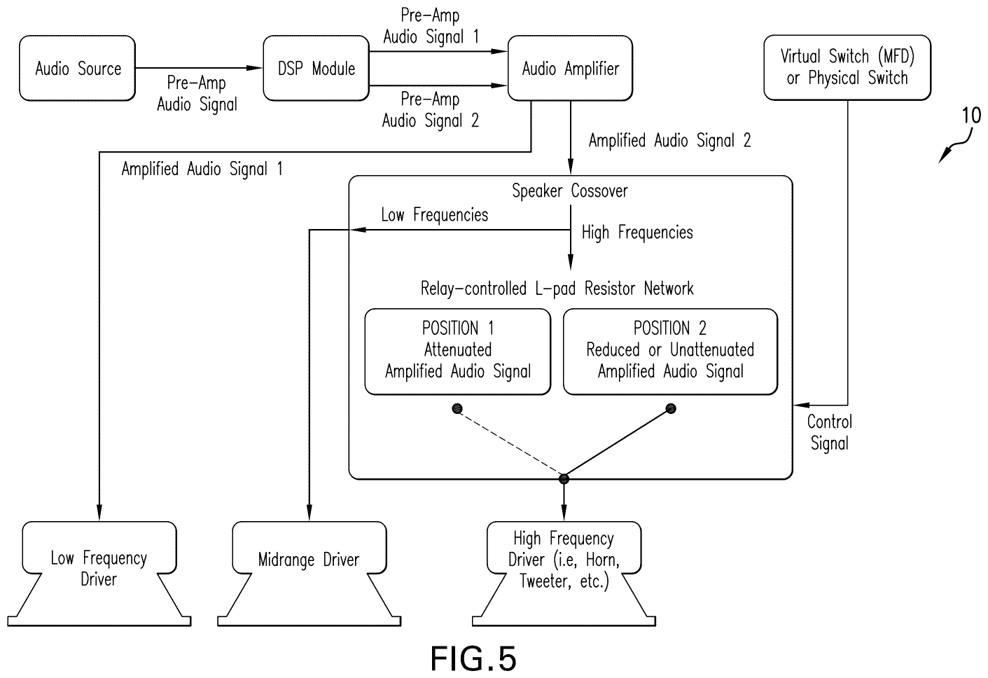

Now additionally referring to FIG. 5, there is shown another embodiment of audio attenuation system 10. In FIG. 5 there is shown an external passive module with crossover and switchable attenuation of a 3-way system with 3 separate drivers.

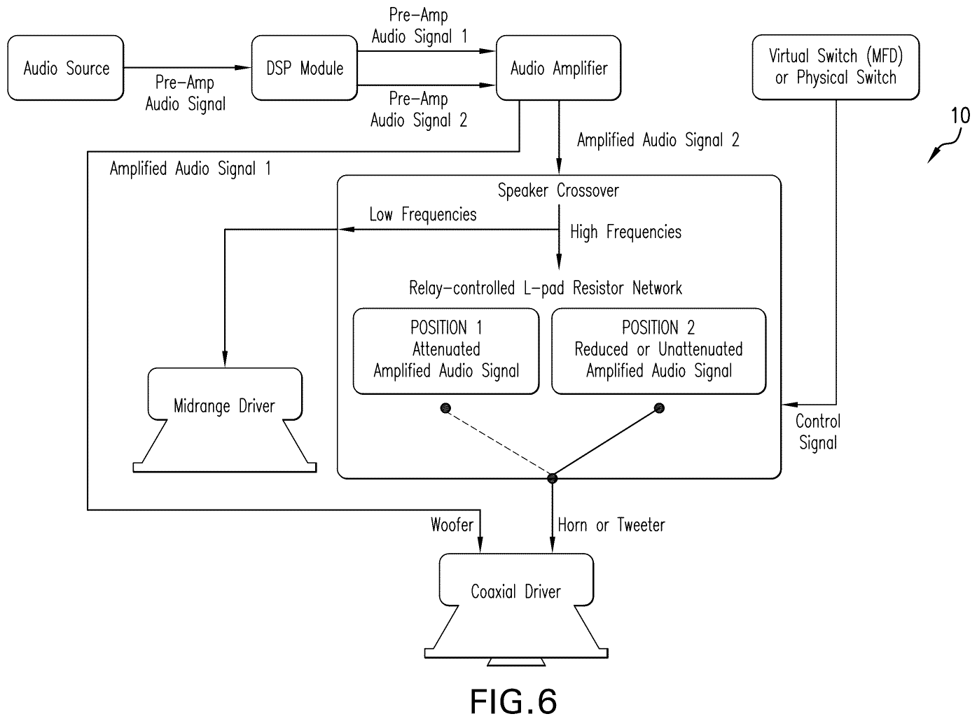

Now additionally referring to FIG. 6, there is shown another embodiment of audio attenuation system 10. In FIG. 6 there is shown an external passive module with crossover and switchable attenuation of a 3-way system with coaxial driver and midrange driver.

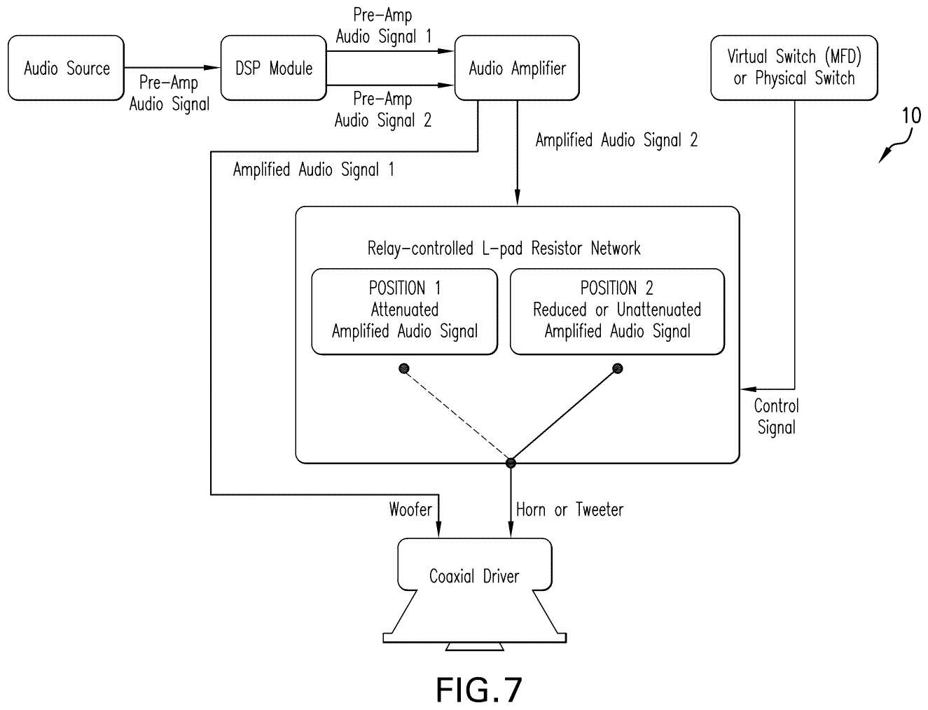

Now additionally referring to FIG. 7, there is shown another embodiment of audio attenuation system 10. In FIG. 7 there is shown an external passive switchable attenuation of a 2-way coaxial speaker.

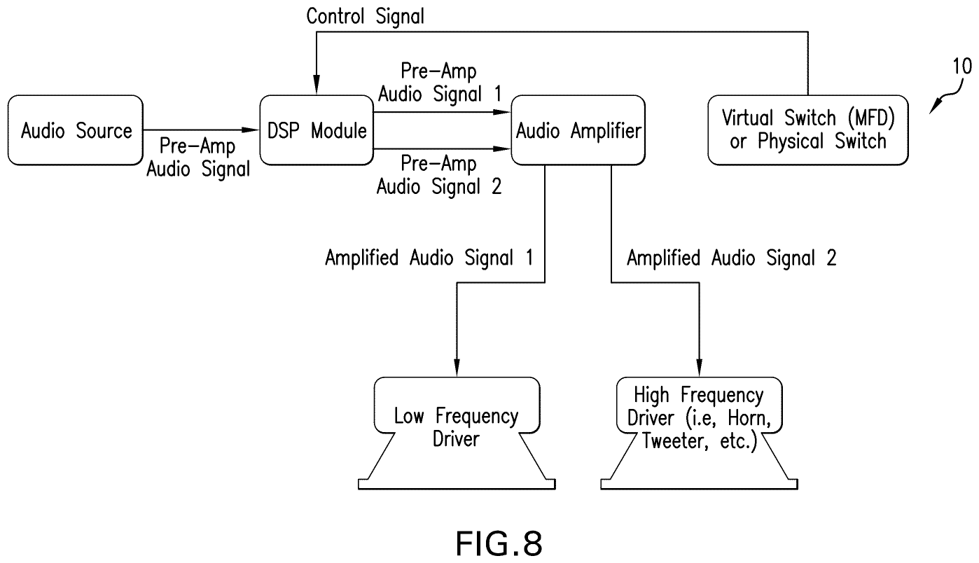

Now additionally referring to FIG. 8, there is shown another embodiment of audio attenuation system 10. In FIG. 8 there is shown an active attenuation within a Digital Signal Processor (DSP) of a 2-way with 2 separate drivers.

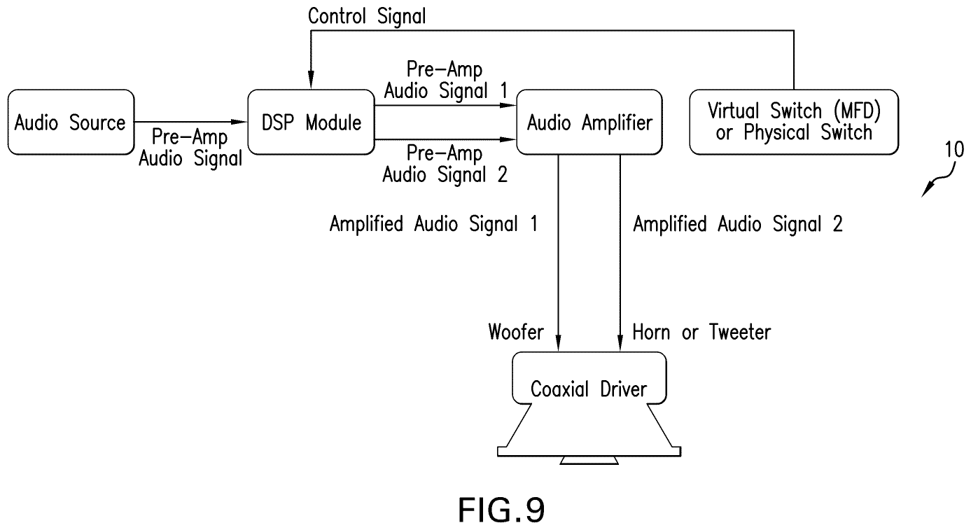

Now additionally referring to FIG. 9, there is shown another embodiment of audio attenuation system 10. In FIG. 9 there is shown an active attenuation within the DSP of a 2-way coaxial speaker.

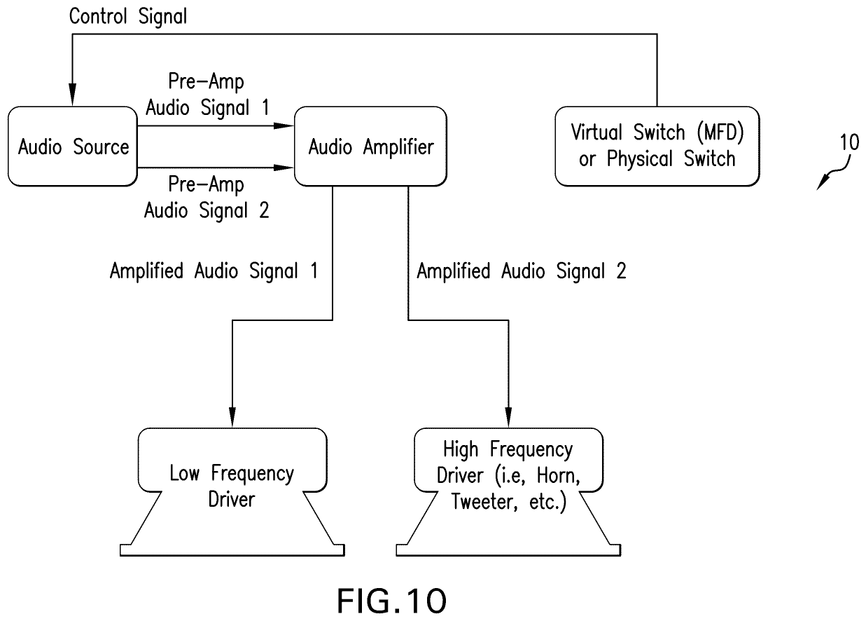

Now additionally referring to FIG. 10, there is shown another embodiment of audio attenuation system 10. In FIG. 10 there is shown an active attenuation within the audio source unit of a 2-way with 2 separate drivers.

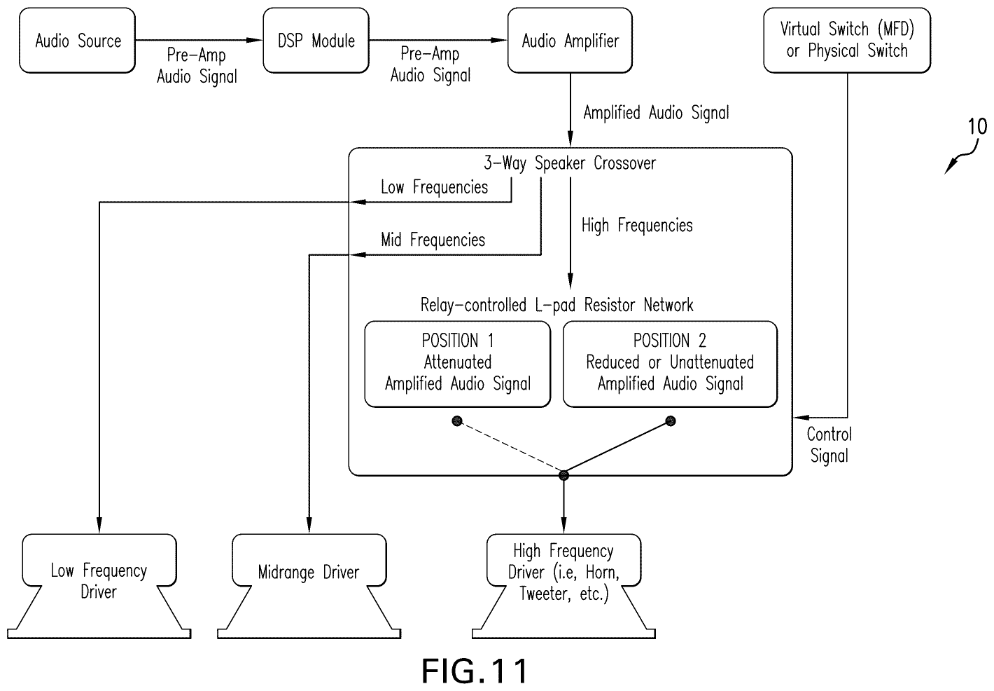

Now additionally referring to FIG. 11, there is shown another embodiment of audio attenuation system 10. In FIG. 11 there is shown an external passive module with 3-way crossover and switchable attenuation of a 3-way system with 3 separate drivers.

As discussed above relative to method 100, a triggering event that causes a control signal 34 to be sent to activate the attenuation of an audio signal according to system 10, can among other triggering events, include:
A manual button or switch to enable/disable;
An automatic enable/disable based on a selected tow mode (ski, wake, surf, etc.);
An automatic enable/disable based on distance from the shoreline;
An automatic enable/disable based on boat speed or engine RPM.

Marine audio attenuation method 100 is for use with audio systems installed on watercraft 12. Basically method 100 includes the steps of acquiring location information 102 of the watercraft; determining 106 if watercraft 12 is in a selected location; and reducing an audio level 110 delivered to speakers 14, 36 attached to watercraft 12 if it is in the selected location, such as within a preselected distance of X units from a shore.

More specifically, when watercraft 12 is in the selected location, as determined at step 106 then watercraft 12 is less than the selected distance X from a shore of a body of water in which watercraft 12 is operating. The location information coming from a position locating system PLS, if the watercraft is less than the selected distance X to the shore, then the selected location is confirmed, and method 100 proceeds to step 108. At step 108 it is determined if the audio level of the audio system is operating at a level greater than predetermined level Y. If the audio level is above level Y, then method 100 proceeds to step 110 where a command is prepared to reduce the audio level to level Y.

Is should be understood that level Y can be a level of no, or zero audio, so that method 100 is carrying out a complete muting of the audio level. As method 100 proceeds to step 112 a delay of Z time units is carried out. This can be thought of as being carried out two different ways. First, step 112 of delaying the method can be done after the audio level is reduced thereby holding the audio level at a reduced level Y for a preselected time Z. The second way step 112 can be carried out is that delay Z is carried out before the audio level is reduced to audio level Y thereby holding the audio at an unattenuated level for a preselected time Z before attenuating the audio level. Both can be true so that changes are delayed so that method 100 can revoke the change if the location of watercraft 12 changes so that it is now more than X units from shore. This advantageously incorporates a hysteresis into the system to prevent method 100 from oscillating unnecessarily between attenuated and unattenuated audio levels.

The inverse of the attenuation brought about in method 100 takes place when watercraft 12 is moved outside of the selected area and is part of system 10.

The acquiring of location information step 102 is accomplished using position locating system PLS. Position locating system PLS compares the location of watercraft 12 relative to a border of a body of water or a shore in which the watercraft is operating, for example by using mapping data of the geographical location. Further position locating system PLS can include sensors that sense a border of the body of water or the shore. For example, position locating system PLS can sense the shore using an optical system, which can include cameras sensitive to visible or non-visible light. Further, position locating system PLS can utilize a lidar system to sense the presence and distance to a shore.

Position locating system PLS includes a Global Positioning System that compares the location of watercraft 12 relative to a border of a body of water in which the watercraft is operating by using mapping coordinates.

### COMPONENT REFERENCE LISTING

10. Audio attenuation system
12. Watercraft, boat
14. Tower speakers, speakers
16. Tower
18. Audio projection
20. Audio projection
22. audio source
24. Pre-Amp Audio Signal
26. Audio amplifier
28. Amplified audio signal
30. Switchable attenuation module
32. Switch
34. Control Signal
36. Speakers
38. Switched output
40. Switched output
100. Method
102. Determining location step
104. Calculating step
106. Decision step
108. Another decision step
110. Adjusting audio step
112. Delaying step
PLS. Position Locating System
X. units of distance
Y. Audio level limit
Z. Seconds of time

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A marine audio attenuation method for use with an audio system installed on a watercraft, the method comprising the steps of:
acquiring location information of the watercraft;
determining if the watercraft is in a selected location; and
reducing an audio level delivered to speakers attached to the watercraft if the watercraft is in the selected location.

2. The method of claim 1, wherein the determining if the watercraft is in the selected location step is carried out by determining if the watercraft is less than a selected distance from a shore of a body of water in which the watercraft is operating by using the location information, if the watercraft is less than the selected distance to the shore then the selected location is confirmed.

3. The method of claim 2, wherein the reducing step is a complete muting of the audio level.

4. The method of claim 2, further comprising a step of delaying the method once the audio level is reduced thereby holding the audio at a reduced level for a preselected time.

5. The method of claim 2, further comprising a step of delaying the method before the audio level is reduced thereby holding the audio at an unattenuated level for a preselected time.

6. The method of claim 1, wherein the acquiring location information of the watercraft step is accomplished using a location system.

7. The method of claim 6, wherein the location system compares the location of the watercraft relative to a border of a body of water in which the watercraft is operating.

8. The method of claim 6, wherein the location system senses a border of a body of water in which the watercraft is operating.

9. The method of claim 8, wherein the location system senses the border of the body of water using an optical system.

10. The method of claim 8, wherein the location system senses the border of the body of water using a lidar system.

11. A watercraft, comprising:
a mobile floating structure;
an audio system connected to the structure, the audio system having a marine audio attenuation system; and
a position locating system configured to acquire location information of the watercraft;
the marine audio attenuation system being configured to carry out the steps of:
determining if the watercraft is in a selected location; and
reducing an audio level delivered to speakers attached to the watercraft if the watercraft is in the selected location.

12. The watercraft of claim 11, wherein the determining if the watercraft is in the selected location step of the marine audio attenuation system is carried out by determining if the watercraft is less than a selected distance from a shore of a body of water in which the watercraft is operating by using the location information, if the watercraft is less than the selected distance to the shore then the selected location is confirmed.

13. The watercraft of claim 12, wherein the reducing step of the marine audio attenuation system is a complete muting of the audio level.

14. The watercraft of claim 12, wherein the marine audio attenuation system further includes a step of delaying a further change of the audio level once the audio level is reduced thereby holding the audio at a reduced level for a preselected time.

15. The watercraft of claim 12, wherein the marine audio attenuation system further includes a step of delaying a further change of the audio level before the audio level is reduced thereby holding the audio at an unattenuated level for a preselected time.

16. The watercraft of claim 11, wherein the position locating system uses a Global Positioning System.

17. The method of claim 11, wherein the position locating system compares the location of the watercraft relative to a border of a body of water in which the watercraft is operating by using map coordinates.

18. The watercraft of claim 11, wherein the position locating system senses a border of a body of water in which the watercraft is operating.

19. The watercraft of claim 18, wherein the position locating system senses the border of the body of water using an optical system.

20. The watercraft of claim 18, wherein the position locating system senses the border of the body of water using a lidar system.
